(19) United States
(12) Patent Application Publication
(10) Pub. No.: US 2020/0250772 A1
(43) Pub. Date: Aug. 6, 2020

(54) DEVICE AND METHOD FOR SHARING USE OF A MOBILE SERVICE VEHICLE

(71) Applicant: VOLKSWAGEN AKTIENGESELLSCHAFT, Wolfsburg (DE)

(72) Inventors: Sebastian HÖFLICH, Lübeck (DE); Volker RÖMMELER, Lauingen am Elm (DE); Jan WEHINGER, Braunschweig (DE)

(21) Appl. No.: 16/758,525

(22) PCT Filed: Aug. 28, 2018
(86) PCT No.: PCT/EP2018/073152

§ 371 Date: Apr. 23, 2020

(30) Foreign Application Priority Data
Oct. 27, 2017 (DE) 10 2017 219 347.6

(51) Int. Cl. G06Q 50/14; G06Q 50/30; G06Q 10/04; G06Q 10/06; G01C 21/34

(52) U.S. Cl. CPC G06Q 50/14; G06Q 50/30; G05D 1/0088; G06Q 10/06315; G01C 21/3438; G06Q 10/047

(57) ABSTRACT

A computer program product, a signal sequence, a device and a method for sharing use of a mobile service vehicle which includes a vehicle carriage and an interconnected passenger compartment specifically equipped for providing a service during the journey. The method includes determining a need of a first client for obtaining the service during the journey, determining a need of a second client fir obtaining the service during the journey, automatically determining that the first client and the second client agree to sharing the journey in the mobile service vehicle, and automatically determining a route for the mobile service vehicle along which the first client and the second client at least intermittently share use of the mobile service vehicle in response to both parties being agreeable.

### PRIORITY CLAIM

This patent application is a U.S. National Phase of International Patent Application No. PCT/EP2018/073152, filed 28 Aug. 2018, which claims priority to German Patent Application No. 10 2017 219 347.6, filed 27 Oct. 2017, the disclosures of which are incorporated herein by reference in their entireties.

### SUMMARY

Illustrative embodiments relate to an apparatus, a computer program product, a signal sequence and a method for sharing use of a mobile service vehicle, composed temporarily of a vehicle carrier and a cabin (CAB) connected to the latter and equipped in a service-specific manner, for providing a service during the journey. In particular, illustrative embodiment relate to improved utilization of available mobile service vehicles and improved availability of mobile service vehicles for potential customers.

### BRIEF DESCRIPTION OF THE DRAWINGS

Exemplary embodiments are described in detail below with reference to the attached drawings, in which:

FIG. 1 shows a basic diagram illustrating exemplary embodiments which can be used for CABs in conjunction with a vehicle carrier to achieve a mobile service vehicle;

FIG. 2 shows a schematic illustration of a platform ecosystem for illustrating information flows;

FIG. 3 shows a schematic illustration of a vehicle carrier, two CABs and their mutual interfaces according to an exemplary embodiment of the disclosed technology;

FIG. 4 shows a schematic overview illustration of two users, a mobile service vehicle and an exemplary embodiment of a disclosed apparatus when implementing an exemplary embodiment of a disclosed method; and

FIG. 5 shows a flowchart illustrating an exemplary embodiment of a disclosed method.

### DETAILED DESCRIPTION

Private transportation is currently making rapid advances. On the one hand, jointly used transportation vehicles (car sharing, pool vehicles, etc.) are increasingly in demand and are being offered in an ever more professional way. On the other hand, the automation of private passenger transportation is also advancing at an increasing pace, permitting the occupants of corresponding transportation vehicles to make use of the travel time in other ways.

In contrast, up until now services have usually been offered in stationary facilities (e.g., “retail stores”). Providers of stationary services have hitherto been faced with the problems that they can only achieve high turnover rates in expensive prime locations, that scaling is difficult, that rental contracts tie them to one location in the long term and that the investment costs and the business risk are high.

End customers wishing to experience the service sometimes have to travel long distances and accept high costs for the stationary services. Consequently, the end customer spends not only the traveling time to his place of work but additionally the time to the respective service provider (e.g., restaurant, lawyer, public authority) in his transportation vehicle. At present, a German person spends approximately 60 minutes per day in his transportation vehicle. In addition, many older persons can no longer drive. Autonomous driving makes this possible again.

Depending on the sector, approaches are also known in which the service comes to the customer. For example, hairdressing services are offered at home or traveling retail traders (the “egg man”) stop by in residential areas to sell goods there.

The provision of services to passengers is already known in isolated cases. For example, gastronomic services can be used in long-distance trains or audiovisual contents (“on-board cinema”) can be consumed.

DE 20 2015 106 556 U1 discloses a mobile apparatus for the mobile provision of different services of a modular design, comprising a drive unit, an energy storage unit and/or associated electronics. A replaceable service module, which can comprise, for example, a faucet module, a cooling module, an ice module or a wet section, is connected to a chassis in a reversible manner by corresponding locking points.

UBER has in the meantime been using bicycle couriers to deliver food directly to a transportation vehicle. It is therefore possible for at least the results of gastronomic services to be enjoyed in conventional transportation vehicles at minimum additional cost. On the other hand, the transportation vehicles themselves are not embodied in a service-specific manner. In addition, the service is not provided in the transportation vehicle but rather ends at the transportation vehicle door with the handing over of the food.

www.luxurymobilebarbershop.com offers a mobile hairdressing salon in which the customer defines the location of the service (for example, airport car park), and the driver drives the mobile hairdressing salon to the defined destination to provide the service there.

Services which are offered in transportation vehicles already offer on-demand services nowadays, particularly in the luxury segment. These services provide their end customers with geographical independence, a saving in time and exclusivity, but usually at a price which is too high for large customer groupings. Services which are offered in transportation vehicles can nowadays usually be found in the luxury segment owing to high investment costs and lack of capacity. The reasons for this are that the transportation vehicle has to be bought for conversion, the conversion requires a large amount of manual work, few standard components are available, the service provider has to travel long distances between the customers, and finally the operative management (payment, booking, taxes) has to be dealt with independently by the service provider. In addition, extensive modifications of transportation vehicles are always associated with costly individual acceptance procedures at the relevant authorities.

Taking the above-mentioned prior art as a starting point, disclosed embodiments increase the utilization of available mobile service vehicles. Disclosed embodiments also increase the availability of mobile service vehicles for potential customers.

The disclosed embodiments are based on the fundamental idea that the consumption willingness of passengers is fundamentally higher than if the same person must spend freely available time on the consumption of a service.

To better adapt the consumption of services during transportation to the requirements of the service provider and the customer, the disclosed embodiments are based, for example, on the concept of providing transportation vehicle platforms having all technical units needed for autonomous driving, such as chassis, drive unit etc., which can be connected, if necessary, to passenger compartments tailored to the provision of a service during the journey. The passenger compartments are referred to as “CABs” within the scope of the present disclosure. “CAB” stands for “cabin”.

In other words, a CAB is a transportation vehicle superstructure which is adapted for a specific service or a group of services and contains all interfaces to accommodate and operate the device needed to provide the service.

The CAB can therefore be understood as meaning a mechanical unit which can be connected as such to the transportation vehicle platform/the vehicle carrier via predefined interfaces. The interfaces ensure a mechanically reversible, but reliable connection between the CAB and the vehicle carrier. Further interfaces can be configured to transmit energy, in particular, electrical energy, between the CAB and the vehicle carrier. These interfaces are also reversible. Further operating resources (fluids), mechanical energy transmission methods or mechanisms, for example, shafts, gearwheels or the like, for mechanically transmitting energy from the vehicle carrier to the CAB, as well as radio connections and/or a data connection between the individual CAB and the vehicle carrier as well as their modules may be provided. For all IT connections of the vehicle carrier to the CAB, electrical and/or optical lines, in particular, bus systems, are appropriate as interfaces, for example.

To make it possible to configure a mobile unit (also “mobile service vehicle”) composed of a vehicle carrier and a CAB in a cost-effective and rapid manner and with little susceptibility to faults, provision can be made for all the interfaces between the CAB and the vehicle carrier to be arranged in an essentially identical direction corresponding to one another. In other words, a CAB can be engaged mechanically with the vehicle carrier in a first direction, in which case rails, for example, ensure a form-fitting connection between the CAB and the vehicle carrier. The same direction can be provided for the energy connection between the vehicle carrier and the CAB. It can be ensured that a correct mechanical connection between the vehicle carrier and the CAB automatically results in a correct energy connection of the vehicle carrier to the CAB. The same can apply to the interfaces for transmitting operating resources. Insofar as data are also to be interchanged between the CAB and the vehicle carrier (e.g., bidirectionally), it is possible, for example, to arrange, correspondingly, circuit-switching interfaces and to close them automatically when the connection is formed between the vehicle carrier and the CAB. However, this does not rule out a wireless transmission of data between the vehicle carrier and the CAB, for which purpose interfaces can likewise be provided. A plurality of interfaces, in particular, standardized interfaces which are essentially the same, can at least be spatially combined and can be arranged in a reversible manner, but protected from undesired release, at corresponding positions on the vehicle carrier/the CAB.

By virtue of the above-mentioned standardization, boundary conditions which are necessary for providing services during the journey can be provided, which conditions enable a considerable reduction in costs and a hitherto unrivaled degree of individualization of transportation vehicles. While the CABs provide the service providers with predefined frameworks, to offer their service in a reliable and suitable way for the users, the vehicle carrier ensures efficient, comfortable, rapid and time-saving transportation, in particular, in the case of vehicle carriers which are capable of automatic driving. As a result, an individual service is offered to persons who are elderly or unfit to drive as well as children during the journey.

The above-mentioned concept composed of a vehicle carrier and a CAB makes it possible to provide individualized services while traveling, in which case the described concept constitutes the physical platform which is made available to potential customers in conjunction with a digital intermediary platform (server). The technology which is disclosed here describes the interaction between the individual components and players in the platform ecosystem. It allows the free time which comes about as a result of the autonomous driving or taxi journeys to be used and monetarized in an optimum way.

Problems of various players are solved in the platform ecosystem. In this context, it is necessary to differentiate between end customers (use services during the journey), service providers (provide services during the journey, such as, e.g., lawyers) and microservice providers (provide modules for equipping the transportation vehicles). The modules do not have to be physical or to relate to the concrete internal equipment of the CAB but instead could also be software modules, e.g., a presentation of a restaurant menu on a display.

The provision of mobile service vehicles composed of the vehicle carrier and CAB can be effected, for example, by a server in conjunction with (mobile) wireless communication terminals (“user terminal”) used by the customer/service provider. An application constitutes the interface to the end customer here. The end customer books the mobile on-demand services via the application. To do this, the end user defines the starting point, destination, starting time and type of service to be provided during the journey. End customers can carry out other tasks via the application, for example, can send requests, view search results, book mobile service vehicles/services, give ratings and pay for the booked or acquired services.

The service provider can digitally keep available its own profile, by which the end user can be informed of the services offered, customer opinions etc. If the end user decides to obtain a service, his request is displayed on the user terminal belonging to the mobile service provider or in the transportation vehicle thereof. The service provider can accept the request, thus resulting in the combined transportation/service agreement.

Services which can be provided within the scope of the present disclosure can, for example, be divided up into the following forms/categories:

the service can be provided by a person or in an unmanned state (e.g., a hairdresser as opposed to a multimedia presentation), and

individualized CAB or mass-produced goods (e.g., generic restaurant as opposed to a system-gastronomy business).

In summary, the transportation vehicle architecture on which the present technology is based comprises at least two concrete components: the component which is necessary for transportation is referred to as a “vehicle carrier” in which the technology for autonomous driving can be located. In addition, the transportation vehicle superstructure (CAB) is used which contains all the interfaces for accommodating and operating the specific device which is needed to provide the service. The transportation vehicles which are composed of the above-mentioned components are also referred to as a “mobile service vehicle”. They could also be referred to as “physical apps on wheels”, since they are as versatile in terms of their range of functions as smartphone platforms which are individualized by applications.

On the basis of the above-mentioned technology, the above is achieved by a method for sharing use of a mobile service vehicle, composed temporarily of a vehicle carrier and a cabin (CAB) connected to the latter and equipped in a service-specific manner, for providing a service during the journey. In a first operation, a need of a customer to obtain the service during the journey is determined. For example, the customer can initiate a request. Alternatively or additionally, the automatic need to obtain the service can be determined by sensors. For this purpose, sensor data can be compared with predefined references. Alternatively or additionally, a personal calendar belonging to the customer and entries contained therein can be evaluated to determine a need for the future on the basis of the entries and/or in conjunction with a service history of the customer. Alternatively or additionally, a task list of the customer can be used to determine the need to obtain the service. At least part of the range of services offered in the CAB may be required for the customer. For example, in a CAB which offers hairdressing services, a haircut without washing, a hair wash without cutting, only the blow-drying of wet hair or the like can be obtained without further segments of the range of services of the CAB intending to be used. In a corresponding manner, a need of a second customer to obtain the same service during the journey is also determined. In this context, the same service means the same range of services or the same CAB. In other words, it is determined that the second customer needs a similar or identical CAB. The need of the second customer to obtain the service can be determined in a corresponding manner, in which case it goes without saying that identical operations are not needed to determine the respective need in each case. As a result, both the first customer and the second customer are interested in the same CAB to obtain a service. It is then automatically determined that the first customer and the second customer agree to a shared journey in the CAB or a mobile service vehicle comprising the CAB. For this purpose, respective statements of agreement can be evaluated, for example, and the mutual agreement/consensus can be determined in the event of two corresponding statements of agreement. In response to this, a route of the mobile service vehicle, on which the first customer and the second customer at least temporarily share use of the mobile service vehicle, is automatically determined. For example, the first customer and the second customer can cover the journey on a shared route section in the same CAB and/or can obtain a respective service from the range of services of the mobile service vehicle. The automatic determination of the route can take into account the fact that the service to be obtained by the first customer and/or the second customer is obtained while both customers are in the mobile service vehicle/in the CAB. The route section can therefore be jointly used at least as long as the service can be provided at least partially while both customers are in the CAB. Both customers can receive the service at the same time while they are brought closer to their respective destination on the shared route with the mobile service vehicle. In this manner, the utilization of mobile service vehicles used can be increased and the availability of mobile service vehicles with respect to the end customer can be improved. The efficiency and the user acceptance of the disclosed method have a positive effect on the above-mentioned basic concept of the mobile service vehicles.

If a jointly used route/a jointly used route section for the first customer and the second customer is relatively short, it can be automatically determined that the two customers agree to jointly obtain the service in the mobile service vehicle. In other words, the customers can state their agreement to obtain a respective service or the same service in the mobile service vehicle at the same time. Optionally, this can also mean that it is determined that the two customers agree to obtain the service “from the same hand” or from the same service person. If the determination is carried out even before the journey of the mobile service vehicle begins, the route calculation can be carried out on the basis of the agreement of the customers to obtain the services at the same time, and even shorter route sections to be jointly traveled can be made (economically) attractive on all sides by virtue of the service being used by a plurality of customers.

It can be automatically determined that the service belongs to a category which is categorized as “suitable for provision during shared use of the CAB”. This may mean that the CAB or the service is classified as harmless or is even categorized as “synergistic”. Synergies when jointly obtaining a service may arise, for example, for so-called “gaming CABs”. In these, the customers/passengers can play with one another or against one another and can experience an even more authentic gaming experience as a result of the personal proximity. Synergies may also result for training or advisory services since the trainer/advisor can teach two customers at the same time. The synergies may result in increased earnings and/or in a lower end price per customer. An example of a service which can be categorized as “unsuitable for provision during shared use of the CAB” is, for example, a medical examination since infringement of medical confidentiality would virtually automatically occur as a result of the common presence of two passengers during an anamnesis, diagnosis and/or treatment. Such a CAB could therefore be predefined as “fundamentally unavailable” for a shared journey while providing services, for example. In addition, there are digital configuration possibilities, according to which a respective user can declare a respective service per se to be suitable or unsuitable for being obtained during shared use of the journey. A corresponding configuration/preset can also be controlled centrally on the basis of a legal provision and/or on the basis of professional circumstances. At least if an involved entity would not like to/cannot share a CAB in question with other passengers, it is possible to dispense with further signaling effort for any negotiation of the boundary conditions for a shared journey/shared obtaining of the service during the journey.

The customers can express the respective need to obtain the service within the scope of a request for a transportation service. In this context, they may have stated/predefined a respective departure point and a respective destination. The disclosed automatic determination of a corresponding route of the mobile service vehicle can be carried out only if the distance to be jointly traveled is sufficiently long (spatially or in terms of time) to jointly obtain the service, otherwise the automatic determination can be rejected. However, the above-mentioned considerations do not exclude the fact that the two customers select an identical departure point and/or an identical destination. For example, an exhibition center may be a shared departure point of two customers who would like to be brought to the same hotel or to different hotels. Accordingly, a journey to an exhibition center for two different customers can start at the same hotel or at different addresses.

Depending on the type of CAB or the service family/service to be obtained on board, the willingness to share use of the CAB for the individual customer can depend on the circumstances and properties of the potential passenger. For example, age, sex and profession, smoker/non-smoker or a minimum score (quality/number of ratings) may be a significant criterion for the individual customer, on the basis of which the customer declares himself willing or not to share use of the CAB. Accordingly, a first data record containing corresponding details of the first customer can be transmitted to the second customer. The data record can be maintained in an app belonging to the first customer and/or can be managed on a server. In addition, the data record may be composed of a file maintained by the user and a file managed on a server. For example, the user can hold personal data which are supplemented with current ratings of the first customer on a server and are then jointly transmitted to the second customer. The same applies to the opposite case in which details of the second customer are transmitted to the first customer in a second data record. The respective data record can be examined by a customer receiving it and can be used as the basis for a decision. Moreover, the data record can contain an explicit request to state agreement. Moreover, the respective customer can remove any details from the data record before the data record is transmitted to the other customer. This establishes an improved basis for stating the respective agreement to the shared journey in the CAB.

The mutual rating of the customer details/data records can be carried out in a particularly convenient, efficient and predictable manner by preconfigured data records which are referred to as a third data record and a fourth data record below. The first customer and the second customer may have stored requirements imposed on the first and second data records in the third and fourth data records, the compliance with the requirements automatically resulting in their agreement with the customer characterized by the first or second data record being stated. The agreement can also be stored differently in the third/fourth data record with respect to the manner of the shared activity/the shared service consumption. For example, a customer can define lower requirements imposed on the properties and circumstances of the accompanying customer as long as a service is not jointly obtained. In contrast, the customer can define higher requirements imposed on passenger profiles acceptable to him for the circumstance of shared obtaining of a service which he possibly feels to be more intimate. In this manner, a comprehensive comparison to determine the respective agreement to the shared journey in a mobile service vehicle can be carried out quickly and efficiently.

The automatic determination that the first customer and the second customer agree to the shared journey in the mobile service vehicle can also consider collisions or synergies between service parts. For this purpose, it can be automatically determined that a sub-service to be obtained by the first customer and belonging to the range of services of the CAB (for example, a hairdressing service, the sub-service of which comprises only the haircut, but not washing) needs to be provided at the same time as a second sub-service to be obtained by the second customer and likewise associated with the service. This can result, for example, from the duration of the respective sub-service and/or the length of the route to be jointly traveled. Synergies may arise, for example (as already discussed above), in an advisory/training/gaming relationship. In a corresponding manner, however, freedom from collisions may also need to be checked for such sub-services which (on account of whatever circumstances) cannot, should not or must not be provided at the same time. For example, a hairdressing CAB can have only a dryer hood, with the result that, although one customer can use the dryer hood while another customer can have his hair washed, both customers cannot obtain the same sub-service if only one service person is provided on board the CAB. This configuration may require the customers to specify the sub-service(s) to be obtained within the scope of their request for the transportation/service order and to enable an automatic comparison on the basis of the equipment or other circumstances of the mobile service vehicle.

If the mobile service vehicle which is requested by a first customer is currently occupied by a second customer, a query can be automatically output to the second customer to determine whether the latter agrees to the shared journey in the mobile service vehicle. This query can be effected by hardware of the mobile service vehicle, for example. If the second customer cannot access his mobile communication device (for example, owing to service), the query can therefore be addressed to the CAB/the mobile service vehicle and a corresponding output (for example, by a loudspeaker and/or a display) to the second customer can be effected by the CAB/mobile service vehicle. Only in response to positive feedback from the second customer is the route planning adapted, if necessary, and the transportation order accepted for the first customer. In a corresponding manner, the second customer can be (automatically) requested to state his agreement to obtaining a service/sub-service in a temporal manner or with a time delay.

The determination that the mobile service vehicle is already occupied by a second customer can also comprise determining that the second customer would like to obtain or has already obtained the service at the same time as the first customer. It is possible to determine, by sensors, what service is currently obtained by the second customer on board the mobile service vehicle. Alternatively or additionally, a range of services to be obtained by the second customer in future can already be defined, for example, by the second customer when requesting the mobile service vehicle. On the basis of this knowledge, a respective preconfigured data record can be used to determine the respective agreement to the shared use of the CAB, which data record relates to both customers obtaining the service in a temporal manner.

If it is determined (for example, automatically) that the mobile service vehicle is already occupied by a second customer, it is also possible to investigate how long the service to be obtained by the second customer will still last. If it is automatically determined, for example, that the obtaining of the service will be completed before the first customer gets into the mobile service vehicle, data records which are formulated less strictly can be used to automatically determine the mutual agreement to a shared journey than if it is determined that the service will still be obtained by the second customer after the first customer has gotten in or would even be obtained by both customers jointly/at the same time. This makes it possible to consider a comprehensive information situation and detailed circumstances, thus ensuring the best possible customer acceptance for CABs to be jointly used.

A second disclosed embodiment proposes an apparatus for sharing use of a mobile service vehicle, composed temporarily of a vehicle carrier and a CAB, for providing a service during the journey. The apparatus comprises a data input which can be connected to an antenna for mobile communication, for example. The data input may be a bus subscriber, a client mastering the Internet protocol or the like. The apparatus additionally has an evaluation unit (for example, a programmable processor, an electronic control unit, a microcontroller or the like). By the evaluation unit and the data input, the apparatus is configured to determine a need of a first customer to obtain the service or at least part of the range of services offered in the CAB during the journey. A corresponding need of a second customer to obtain the same service during the journey can also be determined. It is then automatically determined that both customers agree to a shared journey and to obtaining a service jointly/at the same time in the mobile service vehicle. In response to this, a route of the mobile service vehicle, on which the first customer and the second customer at least temporarily share use of the mobile service vehicle and obtain service packages, for which the CAB is configured/set up, jointly and/or at the time same time, is automatically determined. In this manner, the apparatus is configured to implement the method according to the first disclosed embodiment, with the result that reference is made to the above statements with regard to the features, combinations of features and the benefits resulting therefrom to avoid repetitions.

A third disclosed embodiment proposes a computer program product which can be a data memory and on which instructions are stored which enable a programmable processor to carry out the method according to the first disclosed embodiment. The computer program product may be a CD, a DVD, a Blu-ray disc, a flash memory, a hard disk, RAM/ROM, a cache etc.

A fourth disclosed embodiment proposes a signal sequence representing instructions which enable a programmable processor to carry out the operations according to the first disclosed embodiment. This also protects the IT provision of the instructions if the storage method or mechanism required for this purpose are outside the area of validity of the attached claims.

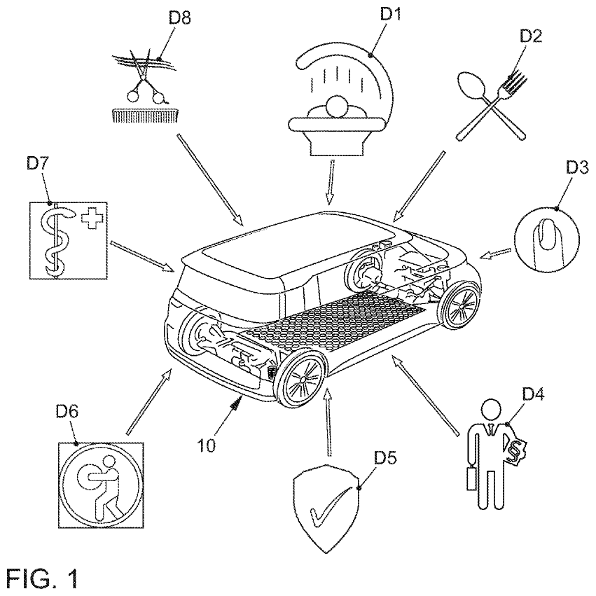

FIG. 1 shows a schematic illustration of a vehicle carrier 10 of a mobile service vehicle according to at least one exemplary embodiment of the technology disclosed here. The vehicle carrier in this case provides all features which are required for transportation, in particular, automatic transportation. The chassis, the drive train, the energy store, longitudinal/lateral control logic and devices, exterior lighting, etc. are mentioned merely by way of example. Within the scope of the technology disclosed in the present case, CABs (not illustrated) are used to specifically configure the vehicle carrier to provide a respective service D1 to D8. For example, an irradiation and/or tanning device D1, such as a CAB, can be connected to the vehicle carrier 10 to be able to offer the “tanning” service. For example, a UV irradiation unit and/or a tanning shower may be included. To be able to provide gastronomic services D2, a restaurant CAB may be connected to the vehicle carrier 10. The preparation of food and the consumption of the latter can be enabled by the configuration of the CAB. A cosmetic or nail care service D3 may require, for example, the CAB to have special workbenches, an extraction system for rapidly exchanging the interior air and particularly bright illumination devices (so-called spotlights). To provide legal advisory services D4, a library and/or at least two seating areas may be provided in an accordingly configured CAB. The same applies to an insurance advisory service or financial advisory service D5. Video conferencing hardware and a large screen for displaying graphics and other presentation contents may be provided in this case. Rehab services D6 and medical services D7 can also be supported in the best possible manner by the configuration of a respective CAB. For example, examination and/or training devices may be parts of corresponding CABs. To be able to provide hairdressing services D8, a sink, as is conventional in hairdressing salons for washing hair, a 230-V plug for operating a hairdryer, a large mirror and a height-adjustable hairdressing chair can be provided, for example. The above-mentioned CABs can be connected to the vehicle carrier 10 in a mechanically fixed and crash-proof manner via reversible mechanical interfaces. To ensure energy and information flows between the vehicle carrier 10 and the CAB, reversible interfaces illustrated in detail in conjunction with FIG. 3 are proposed.

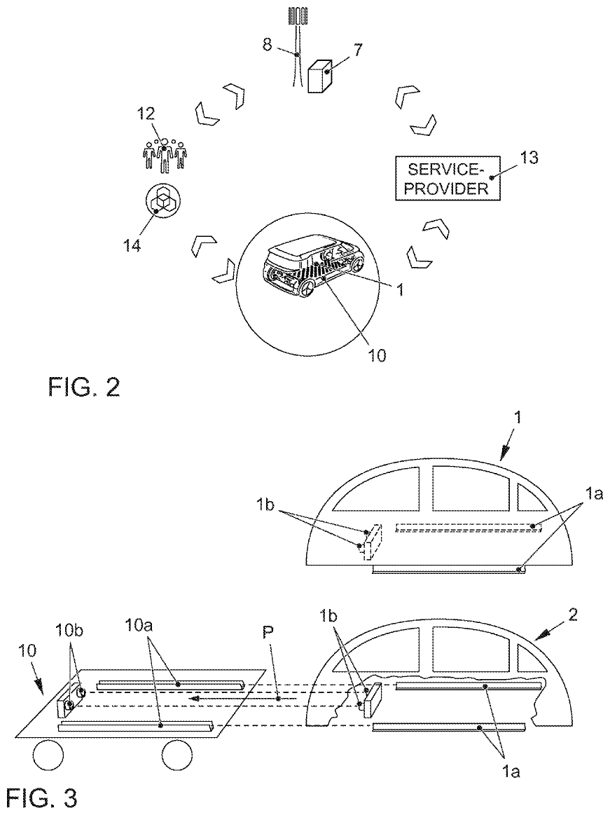

FIG. 2 shows a schematic illustration of a platform ecosystem for illustrating information flows when implementing the technology disclosed in the present case. A microservice provider 14 individualizes the CABs 1 of the mobile service vehicles, which are then connected to a respective vehicle carrier 10 (temporarily or permanently) and are provided. The provision of the mobile service vehicles is carried out by a service provider 13 which determines the need of the users 12 via a server 7 and, for example, a radio tower 8 of a wireless communication network and compares it with the fundamentally available/offered mobile service vehicles. The best possible combinations of offered mobile service vehicle and interested user 12 result in the conclusion of an individual contract regarding the provision of a mobility service and a CAB-specific service. The microservice provider 14 can also provide the individual service or a service package with respect to the end customer and can monitor and ensure the operation of the mobile service vehicle or the CAB for this purpose or can even provide a manual service in a manned mobile service vehicle on board the mobile service vehicle. It goes without saying that the service provider 14 need not be identical to the manufacturer/outfitter of the CAB 1. In this respect, different constellations with respect to the design, the creation and the use of the CABs arise when providing the service with respect to the end customer.

FIG. 3 shows a basic perspective diagram for temporarily connecting a vehicle carrier 10 to a first CAB 1 or to a second CAB 2. Mechanical interfaces 10a which are equipped in a manner corresponding to one another on the vehicle carrier 10 and mechanical interfaces 1a in the CABs 1, 2 ensure a rapid and crash-proof connection between the CAB 1, 2 and the vehicle carrier 10. If information and/or energy is intended to be exchanged by the CAB 1, 2 with the vehicle carrier 10 or the other way round, additional interfaces 1b, 10b corresponding to one another are arranged on the CABs 1, 2 and the vehicle carrier 10 and are likewise engaged with one another in the direction of an arrow P. Alternatively or additionally, further or alternative interfaces between the CABs 1, 2 and the vehicle carrier 10 can engaged with one another in a corresponding manner. For example, a heating/cooling power, hydraulic energy, compressed air, etc. can be exchanged between the CABs 1, 2 and the vehicle carrier 10. The interfaces can be monitored using IT, with the result that a use/journey of the mobile service vehicle is enabled only if contact is properly made with the respective interfaces and the interfaces are accordingly locked. Whereas the illustrated mechanical interfaces 10a of the vehicle carrier 1 are configured with U-shaped or rail profiles which can be engaged with T-shaped profiles illustrated by way of example as interfaces 1a of the CABs 1, 2, it goes without saying that other mechanical interfaces are possible and can possibly be engaged with one another in a direction other than that of the illustrated arrow P. However, if the CABs 1, 2 can be mounted in a jacked-up manner at a suitable height, the vehicle carrier 10 can automatically move under the CAB 2, as illustrated, in which case the interfaces 1b, 1a, 10b, 10a are engaged with one another without the need for a complicated lifting apparatus or the like. If necessary, an air suspension of the vehicle carrier 10 can be used to carry out a slight height adjustment. Whereas, within the scope of the technology disclosed in the present case, a CAB need not necessarily be understood as meaning a passenger compartment with service-specific internal equipment, this is a suitable configuration of the technology disclosed in the present case. Alternatively, in the sense of the technology disclosed in the present case, the CAB may be an only temporary part of the passenger compartment (integrally produced with the vehicle carrier 10). In this configuration, the interfaces illustrated in FIG. 3 (or other suitable interfaces) can be arranged between the CAB and the passenger compartment. The interfaces may be arranged, for example, on the roof and/or in the side panels and/or in the base of the CAB and the passenger compartment.

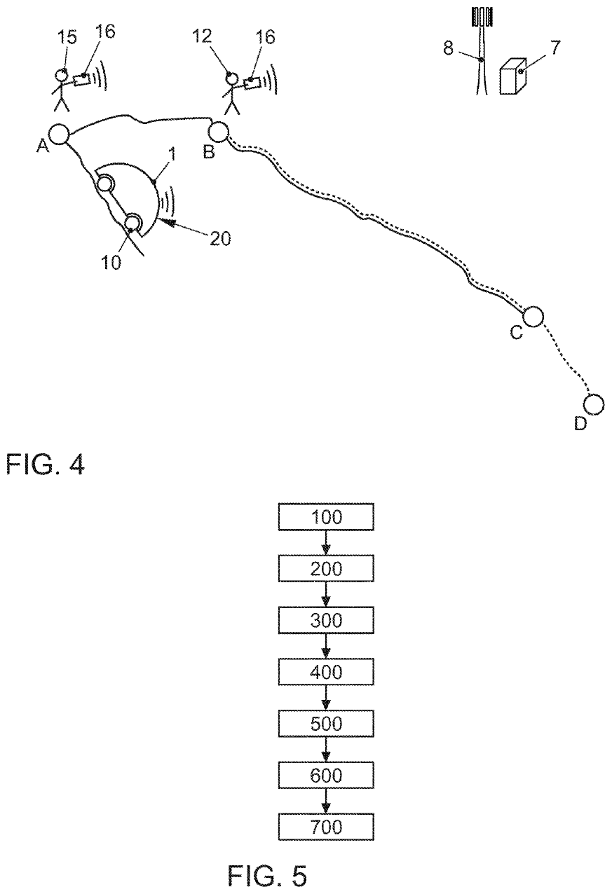

FIG. 4 shows a mobile service vehicle 20 which is temporarily composed of a vehicle carrier 10 and a service-specific CAB 1 and is configured to provide hairdressing services. On account of the fact that both a first customer 12 by his smartphone 16 and a second customer 15 by his smartphone 16 both would like to reach a respective destination C and D and would like to obtain hairdressing services during the journey, an exemplary embodiment of a disclosed apparatus comprising a radio tower 8 as a data input and a server 7 as an evaluation unit has calculated the illustrated route. This route leads the mobile service vehicle 20 to the position A of the second customer 15 where the latter gets in and has his hair washed and cut during the journey to the position B of the first customer 12. At the position B of the first customer 12, the second customer 15 is placed under a drying hood, while the hairdresser can concentrate on washing and cutting the hair of the first customer 12 until the second customer 15 leaves at the destination C of the mobile service vehicle 20. The first customer 12 can now also have his hair dried until arriving at his destination D. The utilization of the CAB 1 can be increased by virtue of the fact that the route B-C to be jointly traveled has been negotiated as accepted by the two customers 12, 15 in accordance with the disclosed embodiments. An exemplary embodiment of the disclosed method is presented for this operation in conjunction with FIG. 5.

FIG. 5 shows operations of an exemplary embodiment of a disclosed method for sharing use of a mobile service vehicle, composed temporarily of a vehicle carrier and a CAB connected to the latter and equipped in a service-specific manner, for providing a service during the journey. In operation at 100, a need of a first customer to obtain the service during the journey is determined. In operation at 200, the same is carried out with respect to a second customer and the same service. In operation at 300, it is automatically determined that the first customer and the second customer agree to the shared journey, and, in operation at 400, it is also determined that the first customer and the second customer also agree on obtaining the service jointly and/or at the same time in the mobile service vehicle. For this purpose, in operation at 500, a first data record representing details of the first customer is transmitted to the second customer and a second data record representing details of the second customer is transmitted to the first customer. The details may define properties or circumstances such as age, marital status, profession, sex, smoker/non-smoker, a photo, a minimum score by service providers/other customers etc. After a successful comparison and therefore a mutual agreement to share use of the mobile service vehicle have been ensured, it is automatically determined, in operation at 600, that the first customer and the second customer have predefined a respective departure point and a respective destination in a respective request which are to be linked by a shared route which is sufficiently long to provide the service during the journey. In other words, after the willingness to share a CAB, known algorithms and information additionally result in the circumstance of also actually sharing use of the CAB on a route to be usefully jointly traveled. Last but not least, in operation at 700, a route of the mobile service vehicle, on which the first customer and the second customer at least temporarily share use of the mobile service vehicle, is automatically determined. In other words, the route can define a first starting point at which the second customer gets into the mobile service vehicle, can define a second starting point at which the first customer gets into the mobile service vehicle, can determine a route to be jointly traveled by both customers to an intermediate destination at which one of the two customers leaves the mobile service vehicle again and can determine a target position at which the other customer also leaves the mobile service vehicle again. The route can be dynamically adapted (as is conventional and known in the prior art) to changing traffic situations and other circumstances provided that there is a corresponding need.

### LIST OF REFERENCE SIGNS

1 First CAB
1a Mechanical interface of the CAB
1b IT/energy interface of the CAB
2 Second CAB
7 Server
8 Radio tower
10 Vehicle carrier
10a Mechanical interface of the vehicle carrier
10b Energy/IT interface of the vehicle carrier
12 User
13 Service provider
14 Microservice provider
15 Second user
16 Smartphone
20 Mobile service vehicle
100-700 Method operations
A, B Departure point/position
C, D Destination
D1-D8 Services
P Arrow

1. A method for sharing use of a mobile service vehicle, composed temporarily of a vehicle carrier and a cabin CAB, equipped in a service-specific manner, for providing a service during a journey, the method comprising:
determining a need of a first customer to obtain the service during the journey;
determining a need of a second customer to obtain the service during the journey;
automatically determining whether the first customer and the second customer agree to the shared journey in the mobile service vehicle and, based on the agreement,
automatically determining a route of the mobile service vehicle, on which the first customer and the second customer at least temporarily share use of the mobile service vehicle.

2. The method of claim 1 further comprising automatically determining that whether the first customer and the second customer agree to jointly obtain the service in the mobile service vehicle.

3. The method of claim 1, further comprising automatically determining whether the service belongs to a category which is categorized as “suitable for provision during shared use of the CAB”.

4. The method of claim 1, further comprising automatically determining whether the first customer and the second customer have predefined a respective departure point and a respective destination in a respective request, which are to be linked by a shared route which is sufficiently long to provide the service during the journey.

5. The method of claim 1, wherein the determination whether the first customer and the second customer agree to the shared journey in the mobile service vehicle comprises transmitting a first data record representing details of the first customer to the second customer and transmitting a second data record representing details of the second customer to the first customer.

6. The method of claim 5, further comprising:
reading a third data record preconfigured by the second customer;
comparing the first data record and the third data record and, based on the result,
automatically determining whether the second customer agrees to the shared journey in the mobile service vehicle, and/or
reading a fourth data record preconfigured by the first customer,
comparing the second data record and the fourth data record and, based on the result, and
automatically determining whether the first customer agrees to the shared journey in the mobile service vehicle.

7. The method of claim 1, further comprising determining whether a first sub-service to be obtained by the first customer and belonging to the service needs to be provided at the same time as and/or with a time delay with respect to a second sub-service to be obtained by the second customer and associated with the service.

8. The method of claim 1, further comprising:
automatically determining whether the mobile service vehicle is already occupied by the second customer and, in response to this,
automatically querying whether the second customer agrees to the shared journey in the mobile service vehicle.

9. The method of claim 8, wherein the determination whether the mobile service vehicle is already occupied by a second customer comprises determining that the second customer would like to obtain the service at the same time as the first customer.

10. The method of claim 8, wherein the determination whether the mobile service vehicle is already occupied by the second customer comprises determining that the second customer will stop obtaining the service before the first customer gets in.

11. The method of claim 8, wherein the determination whether the mobile service vehicle is already occupied by the second customer comprises sensors determining that the second customer is using the service.

12. An apparatus for sharing use of a mobile service vehicle, composed temporarily of a vehicle carrier and a cabin CAB, equipped in a service-specific manner, for providing a service during the journey, the apparatus comprising:
a data input; and
an evaluation unit,
wherein the apparatus is configured to:
determine a need of a first customer to obtain the service during the journey,
determine a need of a second customer to obtain the service during the journey,
automatically determine whether the first customer and the second customer agree to the shared journey in the mobile service vehicle and, based on the agreement,
automatically determine a route of the mobile service vehicle, on which the first customer and the second customer at least temporarily share use of the mobile service vehicle.

13. (canceled)

14. A non-transitory computer readable medium including computer instructions which, when executed on a computer transform the computer into the evaluation unit of the apparatus of claim 12, to cause the evaluation unit to:
determine the need of the first customer to obtain the service during the journey,
determine a need of a second customer to obtain the service during the journey,
automatically determine that the first customer and the second customer agree to the shared journey in the mobile service vehicle and, based on the agreement,
automatically determine a route of the mobile service vehicle, on which the first customer and the second customer at least temporarily share use of the mobile service vehicle perform the method of claim 1.

15. (canceled)

16. The apparatus of claim 12, wherein the apparatus automatically determines whether the first customer and the second customer agree to jointly obtain the service in the mobile service vehicle.

17. The apparatus of claim 12, wherein the apparatus automatically determines whether the service belongs to a category which is categorized as “suitable for provision during shared use of the CAB.”

18. The apparatus of claim 12, wherein the apparatus automatically determines whether the first customer and the second customer have predefined a respective departure point and a respective destination in a respective request, which are to be linked by a shared route which is sufficiently long to provide the service during the journey.

19. The apparatus of claim 12, wherein the determination that the first customer and the second customer agree to the shared journey in the mobile service vehicle comprises transmitting a first data record representing details of the first customer to the second customer and transmitting a second data record representing details of the second customer to the first customer.

20. The apparatus of claim 19, wherein the apparatus determines a third data record preconfigured by the second customer, compares the first data record and the third data record and, based on the result, automatically determines whether the second customer agrees to the shared journey in the mobile service vehicle, and/or reads a fourth data record preconfigured by the first customer, compares the second data record and the fourth data record and, based on the result, and automatically determines whether the first customer agrees to the shared journey in the mobile service vehicle.

21. The apparatus of claim 12, wherein the apparatus determining whether a first sub-service to be obtained by the first customer and belonging to the service needs to be provided at the same time as and/or with a time delay with respect to a second sub-service to be obtained by the second customer and associated with the service.

22. The apparatus of claim 12, wherein the apparatus automatically determines whether the mobile service vehicle is already occupied by the second customer and, in response to this, automatically queries whether the second customer agrees to the shared journey in the mobile service vehicle.

23. The apparatus of claim 22, wherein the determination whether the mobile service vehicle is already occupied by a second customer comprises determining whether the second customer would like to obtain the service at the same time as the first customer.

24. The apparatus of claim 22, wherein the determination whether the mobile service vehicle is already occupied by the second customer comprises determining whether the second customer will stop obtaining the service before the first customer gets in.

25. The apparatus of claim 22, wherein the determination whether the mobile service vehicle is already occupied by the second customer comprises sensors determining whether the second customer is using the service.
